(19) United States
(12) Patent Application Publication
(10) Pub. No.: US 2003/0097757 A1
(43) Pub. Date: May 29, 2003

(54) Branch shears structure

(76) Inventor: Jeng-Yang Chung, Taichung (TW)

Correspondence Address: 58, MA YUAN WEST ST., TAICHUNG, TW

(21) Appl. No.: 10/012,156

(22) Filed: Nov. 29, 2001

(51) Int. Cl. B26B 13/26

(52) U.S. Cl. 30/249; 30/296.1

(57) ABSTRACT

A branch shears structure includes a fixed blade, a sleeve secured on a lower portion of the fixed blade, a bar secured in the sleeve, a first pulley mounted on the sleeve, a mobile blade pivotally mounted on a mediate portion of the fixed blade, an elongated linking plate having a lower portion pivotally mounted on an upper portion of the fixed blade, a short linking plate having a first end pivotally mounted on the mobile blade and a second end pivotally mounted on the elongated linking plate, a second pulley mounted on an upper portion of the elongated linking plate, a rope in turn passing through the first pulley and the second pulley and extending outward from the second pulley for pulling the elongated linking plate which moves the short linking plate which moves the mobile blade to pivot relative to the fixed blade, and a tension spring having a first secured to the fixed blade and a second end secured to the elongated linking plate.

### BACKGROUND OF THE INVENTION

1. Field of the Invention

The present invention relates to a branch shears structure, and more particularly to a branch shears structure which can be used for shearing branches highly located on the fruit tree.

2. Description of the Related Art

A conventional branch shears structure in accordance with the prior art shown in FIGS. 1-3 comprises a fixed blade 10, a sleeve 11 secured on the fixed blade 31 by riveting, a bar 12 secured in the sleeve 11 by means of bolts 13 in conjunction with nuts 14, a pulley 16 rotatably mounted on the sleeve 11 by two wings 15, a mobile blade 21 pivotally mounted on the fixed blade 10 by a bolt 18 which extends through a pivot hole 17 defined in the fixed blade 10, through the mobile blade 21, and through a washer 20, and is screwed in a nut 19, a drive plate 22 having a lower portion pivotally mounted on the fixed blade 10 by the bolt 18 and connected with the mobile blade 21 by a rivet 23 so that the mobile blade 21 is pivoted with the drive plate 22, a U-shaped support bracket 26 secured on the upper portion of the drive plate 22 and defining a through hole 28, a pulley 27 rotatably mounted on the support bracket 26, a rope 29 having a first end secured in the through hole 28 of the support bracket 26 and a second end in turn passing through the pulley 16 and the pulley 27 and extending outward from the pulley 27 to be attached to a drive handle 30, and a tension spring 25 having a first secured to the fixed blade 10 and a second end secured to the upper portion of the driver plate 29. Each of the fixed blade 10 and the upper portion of the driver plate 22 defines a hook hole 24 for securing the first end and second end of the tension spring 25 therein.

As shown in FIG. 2, the mobile blade 21 is pulled by the tension spring 25 to move away from the fixed blade 10 so that the branch shears structure is disposed in an expanded status.

In operation, the bar 12 is held by an operator's one hand while the operator's other hand exerts a force on the drive handle 30 to pull the rope 29 which forces the pulley 27 to move downward, thereby moving the upper portion of the driver plate 12 downward so that the driver plate 22 is pivoted relative to the fixed blade 10 from the position as shown in FIG. 2 to the position as shown in FIG. 3 while the mobile blade 21 is pivoted with the drive plate 22 to move toward the fixed blade 10 from the position as shown in FIG. 2 to the position as shown in FIG. 3 to abut the fixed blade 10 for shearing the highly located branches on the tree.

When the force exerted on the rope 29 is removed, the mobile blade 21 is returned to its original position as shown in FIG. 2 by the restoring force of the tension spring 25 so that the branch shears structure is disposed in the expanded status again.

In such a manner, the operator exerts a force on the drive plate 22 which then exerts the force on the distal end of the mobile blade 21 for pivoting the mobile blade 21. However, the direction of force exerted by the operator is inclined with the longitudinal axis of the mobile blade 21 so that only the vertical component of the force relative to the axis of the mobile blade 21 is effective to rotate the mobile blade 21, and the horizontal component of the force relative to the axis of the mobile blade 21 is inoperative so that the force exerted by the operator has a great deal of loss, thereby wasting the operator's energy.

### SUMMARY OF THE INVENTION

In accordance with one aspect of the present invention, there is provided a branch shears structure comprising:

a fixed blade;

a sleeve secured on a lower portion of the fixed blade;

an elongated bar secured in the sleeve;

a first pulley rotatably mounted on the sleeve;

a mobile blade pivotally mounted on a mediate portion of the fixed blade;

an elongated linking plate having a lower portion pivotally mounted on an upper portion of the fixed blade;

a short linking plate having a first end pivotally mounted on a distal end of the mobile blade and a second end pivotally mounted on the elongated linking plate and located adjacent to the lower portion of the elongated linking plate;

a second pulley rotatably mounted on an upper portion of the elongated linking plate;

a rope in turn passing through the first pulley and the second pulley and extending outward from the second pulley for pulling the elongated linking plate which pushes and moves the short linking plate which pushes and moves the mobile blade to pivot relative to the fixed blade; and

a tension spring having a first secured to the upper portion of the fixed blade and a second end secured to the upper portion of the elongated linking plate.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a conventional branch shears structure in accordance with the prior art;

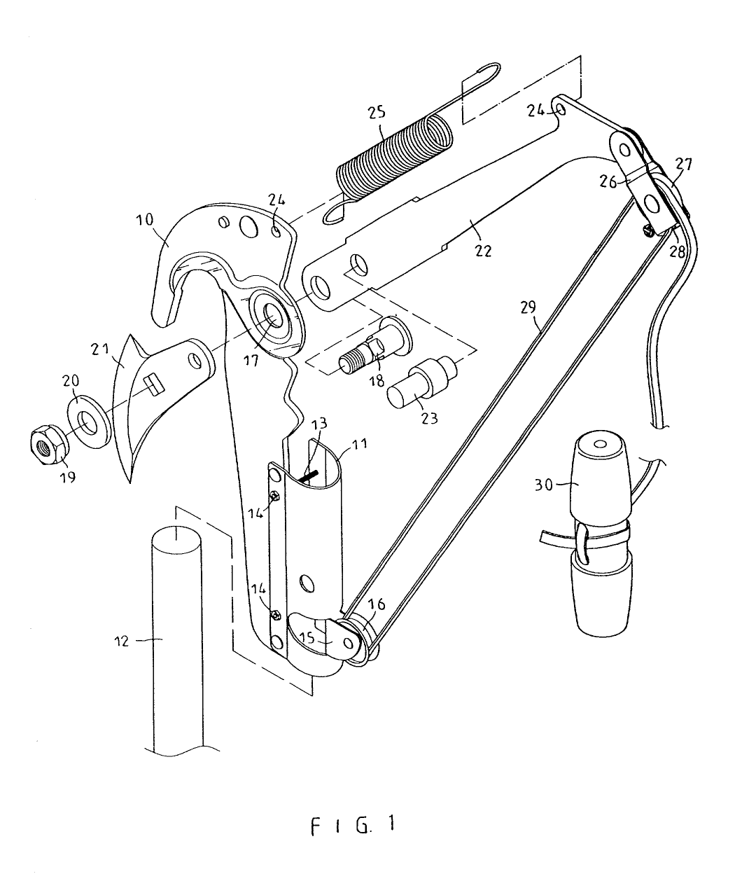

FIG. 2 is a side plan assembly view of the conventional branch shears structure as shown in FIG. 1;

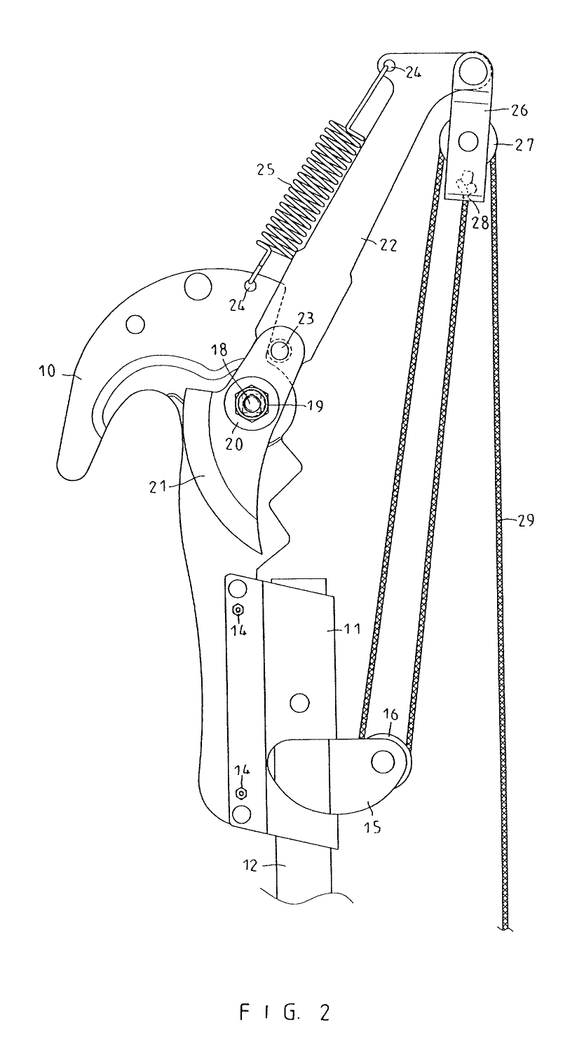

FIG. 3 is an operational view of the conventional branch shears structure as shown in FIG. 2;

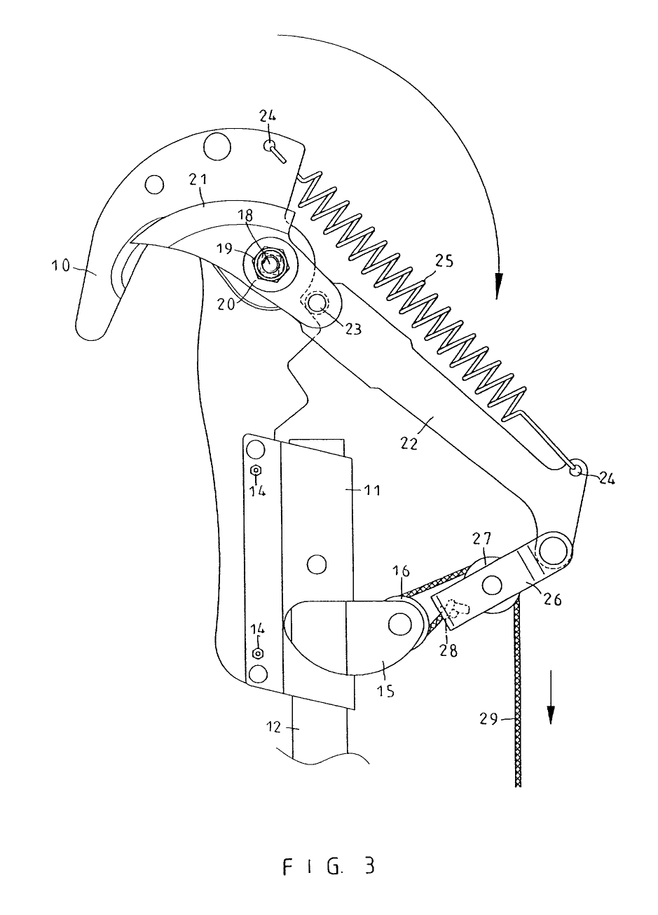

FIG. 4 is an exploded view of a branch shears structure in accordance with the present invention;

FIG. 5 is a side plan assembly view of the branch shears structure as shown in FIG. 4; and

FIG. 6 is an operational view of the branch shears structure as shown in FIG. 5.

### DETAILED DESCRIPTION OF THE INVENTION

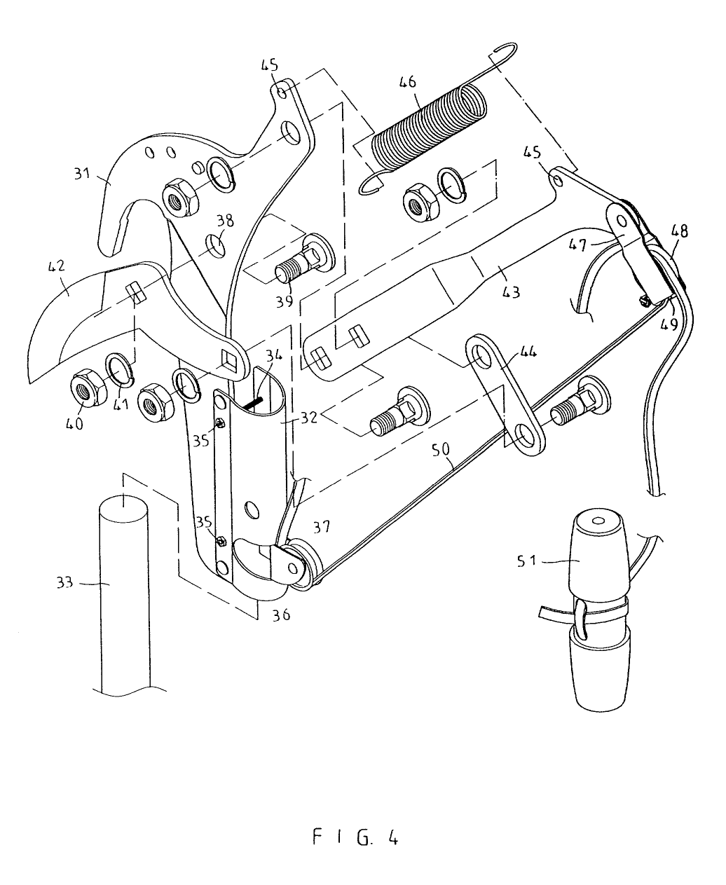

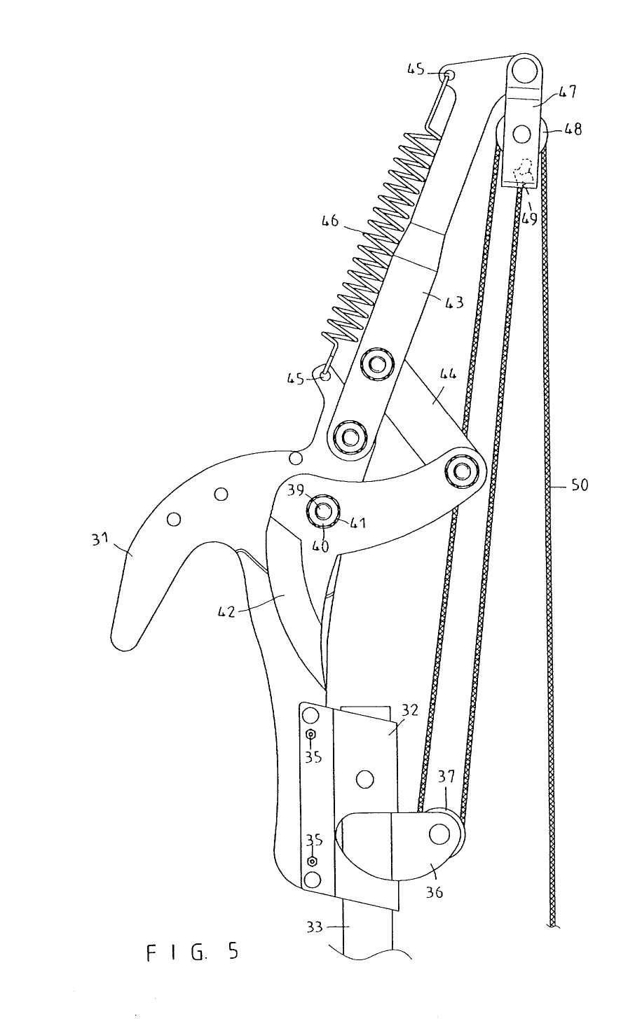

Referring to the drawings and initially to FIGS. 4 and 5, a branch shears structure in accordance with the present invention can be used to shear branches highly located on the fruit tree and comprises a fixed blade 31, a substantially C-shaped sleeve 32 secured on the lower portion of the fixed blade 31 by riveting, an elongated bar 33 secured in the sleeve 32 by means of bolts 34 in conjunction with nuts 35, a first pulley 37 rotatably mounted on the sleeve 32, a mobile blade 42 having a mediate portion pivotally mounted on the mediate portion of the fixed blade 31, an elongated linking plate 43 having a lower portion pivotally mounted on the upper portion of the fixed blade 31, a short linking plate 44 having a first end pivotally mounted on the distal end of the mobile blade 42 and a second end pivotally mounted on the elongated linking plate 43 and located adjacent to the lower portion of the elongated linking plate 43, a U-shaped support bracket 48 secured on the upper portion of the elongated linking plate 43 and defining a through hole 49, a second pulley 48 rotatably mounted on the support bracket 47, a rope 50 having a first end secured in the through hole 49 of the support bracket 48 and a second end in turn passing through the first pulley 37 and the second pulley 48 and extending outward from the second pulley 48 to be attached to a drive handle 51 for pulling the elongated linking plate 43 which pushes and moves the short linking plate 44 which pushes and moves the mobile blade 42 to pivot relative to the fixed blade 31, and a tension spring 46 having a first secured to the upper portion of the fixed blade 31 and a second end secured to the upper portion of the elongated linking plate 43.

Each of the upper portion of the fixed blade 31 and the upper portion of the elongated linking plate 43 defines a hook hole 45 for securing the first end and second end of the tension spring 46 therein.

The mediate portion of the fixed blade 31 defines a pivot hole 38 whereby a bolt 39 in turn extends through the pivot hole 38, through the mediate portion of the mobile blade 42, and through a washer 41, and is then screwed into a nut 40 so that the mobile blade 42 is pivotally mounted on the fixed blade 31.

The lower portion of the sleeve 32 includes two spaced wings 36 for supporting the first pulley 37 therebetween.

As shown in FIG. 5, the mobile blade 42 is pulled by the tension spring 46 to move away from the fixed blade 31 so that the branch shears structure is disposed in an expanded status.

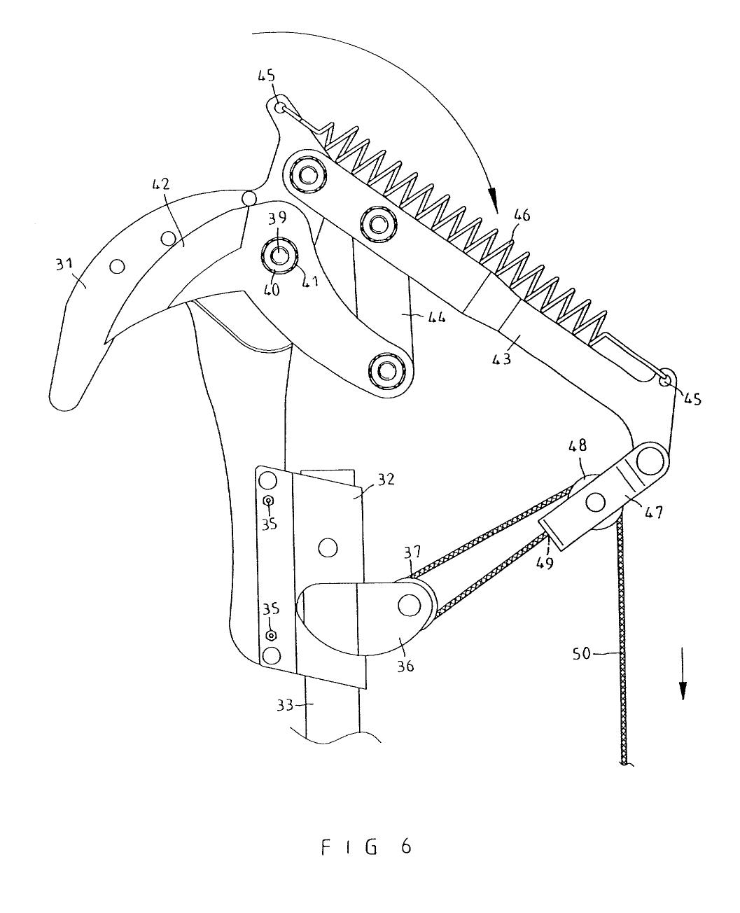

In operation, the elongated bar 33 is held by an operator's one hand while the operator's other hand exerts a force on the drive handle 51 to move the rope 50 downward which forces the second pulley 48 to move downward, thereby moving the upper portion of the elongated linking plate 43 downward so that the elongated linking plate 43 is pivoted relative to the fixed blade 31 from the position as shown in FIG. 5 to the position as shown in FIG. 6 while the short linking plate 44 is pushed by the elongated linking plate 43 to move the distal end of the mobile blade 42, thereby pivoting the mobile 42 which is moved toward the fixed blade 31 from the position as shown in FIG. 5 to the position as shown in FIG. 6 to abut the fixed blade 31 for shearing the highly located branches on the tree.

When the force exerted on the rope 50 is removed, the mobile blade 42 is returned to its original position as shown in FIG. 5 by the restoring force of the tension spring 46 so that the branch shears structure is disposed in the expanded status again.

In such a manner, the elongated linking plate 43 is approximately vertical to the short linking plate 44 so that when the short linking plate 44 is pushed downward by the elongated linking plate 43, the direction of the force exerted by the elongated linking plate 43 is approximately equal to the vertical component of the force such that there almost exists no loss of the horizontal component of the force so that all of the external force can be exerted on the mobile blade 42 for shearing the branches, thereby greatly saving energy.

It should be clear to those skilled in the art that further embodiments may be made without departing from the scope of the present invention.

What is claimed is:

1. A branch shears structure comprising:
a fixed blade (31);
a sleeve (32) secured on a lower portion of said fixed blade (31);
an elongated bar (33) secured in said sleeve (32);
a first pulley (37) rotatably mounted on said sleeve (32);
a mobile blade (42) pivotally mounted on a mediate portion of said fixed blade (31);
an elongated linking plate (43) having a lower portion pivotally mounted on an upper portion of said fixed blade (31);
a short linking plate (44) having a first end pivotally mounted on a distal end of said mobile blade (42) and a second end pivotally mounted on said elongated linking plate (43) and located adjacent to said lower portion of said elongated linking plate (43);
a second pulley (48) rotatably mounted on an upper portion of said elongated linking plate (43);
a rope (50) in turn passing through said first pulley (37) and said second pulley (48) and extending outward from said second pulley (48) for pulling said elongated linking plate (43) which pushes and moves said short linking plate (44) which pushes and moves said mobile blade (42) to pivot relative to said fixed blade (31); and
a tension spring (46) having a first secured to said upper portion of said fixed blade (31) and a second end secured to said upper portion of said elongated linking plate (43).
